(19) United States
(12) Patent Application Publication
(10) Pub. No.: US 2013/0184985 A1
(43) Pub. Date: Jul. 18, 2013

(54) PORTABLE PROCESSING DEVICES

(71) Applicant: Stefan Bollars, Helmond (NL)

(72) Inventor: Stefan Bollars, Helmond (NL)

(21) Appl. No.: 13/822,770

(22) PCT Filed: Sep. 13, 2010
(86) PCT No.: PCT/EP2010/063407

§ 371 Date: Mar. 13, 2013

(51) Int. Cl. G01C 21/34

(52) U.S. Cl. CPC G01C 21/3453
USPC 701/410; 701/409; 340/905

(57) ABSTRACT

This invention concerns a portable processing device 200, such as a navigation device, comprising a positioning device 250,251 for determining a position of the processing device 200, an audio and/or visual output device 240/261, a processor 210 and memory 230 having stored thereon map data. The processor is arranged to determine a position on the map data based on an output from the positioning device 250/251, determine a speed to travel to arrive at a traffic control signal, which switches between two or more conditions to indicate a right of way, when the traffic control signal has a particular condition and cause the audio and/or visual output 240/261 to output an instruction to indicate the determined speed to travel. The invention also concerns a server 302 for interacting with the portable processing device 200.

### FIELD OF THE INVENTION

This invention relates to portable processing devices, servers for communicating with portable processing devices and associated methods. Illustrative embodiments of the invention relate to portable navigation devices (so-called PNDs), in particular PNDs that include Global Navigation Satellite System (GNSS) signal reception and processing functionality and servers for interacting with such devices. Other embodiments relate, more generally, to any type of processing device that is configured to execute software so as to provide instructions for driving and especially, but not exclusively, route planning and navigation functionality.

### BACKGROUND OF THE INVENTION

Portable navigation devices (PNDs) that include GNSS signal reception and processing functionality are well known and are widely employed as in-car or other vehicle navigation systems.

In general terms, a modern PNDs comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM, CDMA and the like.

PND devices of this type also include a GNSS antenna by means of which satellite-broadcast signals, including location positioning data, can be received and subsequently processed to determine a current location of the device.

The PND device may also include electronic gyroscopes and accelerometers which produce signals that can be processed to determine the current angular and linear acceleration, and in turn, and in conjunction with location information derived from the GNSS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed, determined by the PND using a GNSS receiver. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

The routes are calculated using map data based on minimizing a cost function. The cost function will depend on the requirements of the route set by the user. However, the determined route only tells the driver where to drive and not how best to drive on that route for a given criteria, such as fuel efficiency and/or to limit wear and tear on the vehicle.

### SUMMARY OF INVENTION

According to a first aspect of the invention there is provided a portable processing device comprising means for receiving positioning data indicative of a position of the processing device, an audio and/or visual output device, a processor and memory having stored thereon map data, wherein the processor is arranged to determine a position on the map data based on the positioning data, determine a speed to travel to arrive at a traffic control signal, which switches between two or more conditions to indicate a right of way, when the traffic control signal has a particular condition and cause the audio and/or visual output to output an instruction to indicate the determined speed to travel.

In this way, the user can adapt their speed of travel such that they arrive at traffic control signals when the traffic control signals have a desired condition, for example, when the traffic control signals are in a condition indicting that users travelling the route have the right of way. This may increase fuel efficiency and reduce wear and tear on a vehicle as it may reduce the amount a user brakes and accelerates.

The portable processing device may comprise a positioning device that generates positioning data. The positioning device may be a global navigation satellite system (GNSS) receiver for receiving GNSS signals broadcast by satellites of a GNSS. The processing device may be a navigation device, either separate from or in built into a vehicle, that provides positioning and navigation functions. Alternatively, the portable processing device may be a mobile telephone, personal digital assistant (PDA), tablet computer, laptop or similar processing device that can be operated by the user within a vehicle but may not be dedicated to providing positioning and navigation functions (but may provide such functions if programmed with appropriate software). The positioning data may be generated by an external device connected to the portable processing device, for example, a camera, such as a ccd camera, signals generated from sensors onboard the car, for example tacho, radar, accelerometers or the like, or an external GNSS receiver.

The traffic control signal may be a traffic light and the particular condition may be a green light. However, it will be understood that the invention may be applied to other traffic control signals such as traffic control signals for public transport such as level crossings for trains and/or trams.

In one embodiment, the processor is arranged to identify from the map data whether there is a traffic control signal on a route, determine a condition of the traffic control signal at a specified time and the speed to travel to arrive at the traffic control signal when the traffic control signal has a particular condition.

The processing device may comprise a data connection link, such a wireless receiver, for receiving traffic information on the condition of traffic control signals. The processor may be arranged to use the received traffic information to determine a current condition of an identified traffic control signal and from the current condition the speed to travel to arrive at a traffic control signal when the traffic control signal has a particular condition.

The processor may take into account a speed of traffic along navigable paths of the route. Such information may be obtained from speed profiles along the navigable paths stored in the memory, such as those described in WO2009/053410, and/or traffic information received over the data link. The use of information on the speed of traffic as well as the condition of control signals may allow the processor to determine a speed to travel taking into account limitations other road users may place on the maximum speed of travel along a road. For example, with a clear road the “best” speed of travel may be 30 km/h but traffic on the road may only be travelling at 20 km/h preventing the higher speed from being achieved. By utilizing information on speed of traffic along the navigable paths, the processor can take into account the limitations on the speed of travel imposed by traffic, increasing the likelihood that the recommended speed is an achievable speed.

The memory may have stored therein data on regular cycles carried out by the traffic control signals and the processor may be arranged to use the data on regular cycles to determine the speed to travel.

The processor may be arranged to use traffic information received by the processing device to determine the condition of traffic control signals. For example, the processor may determine that at a specified time vehicles at a traffic control signal were stationary and therefore, the traffic control signals must have been in a condition stopping the traffic at this time. The processor may be able to use this information together with information stored in memory on the cyclic nature of the traffic control signals to determine the speed to travel.

In an alternative embodiment, the processing device comprises a wireless receiver for communicating with transmitters, possibly at the roadside or connected with a backend server, that communicate the speed to travel to arrive at an associated traffic control signal when the traffic control signal has a particular condition. Such an embodiment may be advantageous as algorithms carried out by the processor of the device can be simplified and it may be achieved through inexpensive modifications to existing infrastructure.

The route may be a route determined from a destination identified by the user, for example a route determined by the processor using the map data and an appropriate routing algorithm for a specified destination. In this way, the processor can use the knowledge of the route to take into account the turns that will be made in the identification of traffic signals and the determination of the speed to travel. If a specified time of travel is provided, the speed to travel along the route may be pre-calculated before the user commences travelling the route. Adjustments to these speeds to travel may be made as the user travels the route. In the case that a backend server determines the speed to travel, the processor may be arranged to cause the communication of the predetermined route to a backend server over a data link, such as a wireless data link, of the processing device.

Alternatively, the route may be a predicted route determined from an extrapolation of the current direction of travel, for example the processor may identify the traffic control signals by looking ahead on a current path being travelled by a predetermined distance. In this way, the processing device can indicate appropriate speeds to travel in a “free-driving” mode. The disadvantage of such a method is that a driver may turn on to a new path from the current path before reaching identified traffic control signals and the instruction about the speed to travel output via the audio and/or visual output may not be appropriate for the new path.

According to a second aspect of the invention there is provided a server comprising a processor, a data link for communicating with portable processing devices and a data link for receiving information indicative of the condition of traffic control signals, the processor arranged to process the information to determine the condition of the traffic control signals and communicate the condition of the traffic control signals to a remote processing device and/or one or more of the portable processing devices.

The information indicative of the condition of traffic control signals may be current positions and/or speeds communicated to the server from devices, such as navigation devices or mobile telephones, located in vehicles, and/or information obtained from a third party who controls operation of the traffic control signals. The server may also have stored therein statistics on traffic control signals (obtained from a third party or through historical measurements). The server may be connected via a data link to a source of the statistics on traffic control signals to obtain regular updates.

Such a server is advantageous as it removes processing burden away from the portable processing devices and can provide the portable processing devices and/or other processing device with up-to-date information on the traffic control signals.

According to a third aspect of the invention there is provided a server comprising memory having stored thereon map data and data concerning the cyclic condition of traffic control signals, which switch between two or more conditions to indicate a right of way, a processor and a data link for communicating with portable processing devices, the processor arranged to, in response to receiving a position fix from a portable processing device, determine a speed to travel to arrive at at least one of the traffic control signals along the route when the at least one traffic control signal has a particular condition and communicate the speed to travel to the portable processing device.

According to a fourth aspect of the invention there is provided map data of a plurality of navigable paths, the map data identifying traffic control signals, which switch between two or more conditions to indicate a right of way, on the navigable paths and switching cycles carried out by the traffic control signals.

According to a fifth aspect of the invention there is provided a method of providing driving suggestions comprising determining a position on map data based on an output from a positioning device, identifying a traffic control signal, which switches between two or more conditions to indicate a right of way, on a route, determining a speed to travel to arrive at the traffic control signal when the traffic control signal has a particular condition and causing an audio and/or visual output of an instruction to a user of a vehicle indicating the determined speed to travel.

The method may be carried out solely by a navigation device or by a portable processing device or by a combination of the navigation device/portable processing device and a server.

The invention also concerns a data carrier having instructions thereon, which, when executed by a processor, causes the processor to carry out the above described steps.

### BRIEF DESCRIPTION OF THE FIGURES

There now follows, by way of example only, a detailed description of embodiments of the present invention with reference to the accompanying drawings, in which:

FIG. 1 is a schematic illustration of an exemplary part of a Global Positioning System (GPS) usable by a navigation device;

FIG. 2 is a schematic of a navigation device according to one embodiment of the invention;

FIGS. 3a and 3b show the navigation device and a mounting for mounting the navigation device in a vehicle;

FIG. 4 is a schematic of the navigation device communicating with a server;

FIG. 5 is a schematic of a system according to the an embodiment of the invention; and

FIG. 6 is an example of a display in accordance with an embodiment of the invention.

### DETAILED DESCRIPTION OF THE FIGURES

Preferred embodiments of the present invention will now be described with particular reference to a PND. It should be noted, however, that the teachings of the present invention are not limited to PNDs but are universally applicable to any type of processing device that is configured to provide position information using a Global Navigation Satellite System (GNSS). It follows therefore that in the context of the present application, a navigation device is intended to include (without limitation) navigation devices, irrespective of whether that device is embodied as a PND, a navigation device built into a vehicle, or indeed a computing resource (such as a laptop or other portable computer, mobile telephone or portable digital assistant (PDA)) executing route planning and navigation software.

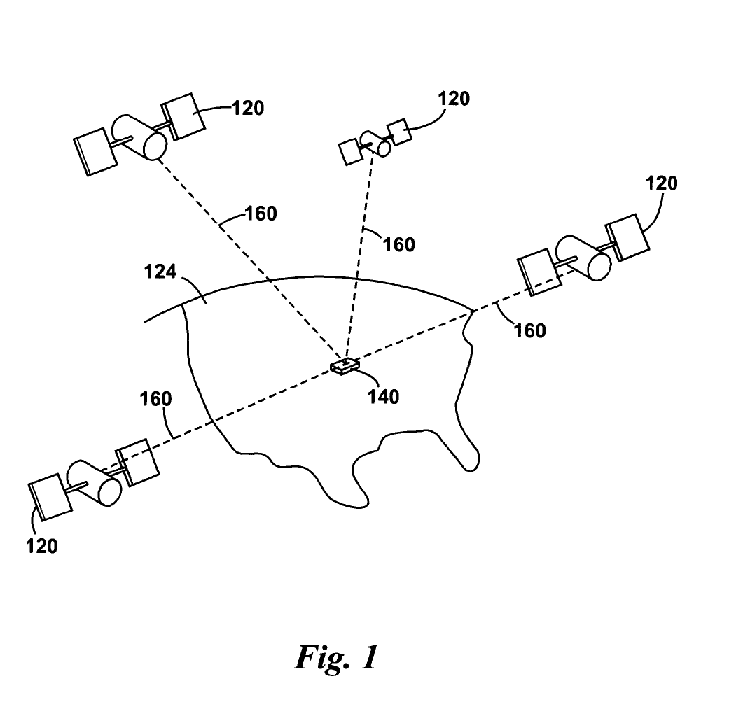

With the above provisos in mind, FIG. 1 illustrates an example view of Global Navigation Satellite System (GNSS) 100, usable by navigation devices 140. In general, GNSS is a satellite-radio based navigation system capable of determining continuous position, velocity, time, and in some instances direction information. A GNSS comprises a plurality of satellites 120 in orbit about the earth 124. The orbit of each satellite 120 is not necessarily synchronous with the orbits of other satellites 120 and, in fact, is likely asynchronous. The GNSS satellites relay their location to receiving units 140 via signals 160. The GNSS receiver 140 receives the spread spectrum GNSS satellite signals 160 and determines its position from the position information relayed by the satellites.

The navigation device of the invention may use GPS, formerly known as NAVSTAR, Galileo, GLOSNASS, or any other suitable GNSS. The GNSS incorporates a plurality of satellites 120 which orbit the earth in extremely precise orbits.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GNSS receiver device 140 generally acquires spread spectrum GNSS satellite signals 160 from at least three satellites 120 for the GNSS receiver device 140 to calculate its two-dimensional position by triangulation. Acquisition of an additional signal, resulting in signals 160 from a total of four satellites 120, permits the GNSS receiver device 140 to calculate its three-dimensional position in a known manner.

The GNSS system is implemented when a device, specially equipped to receive GNSS data, begins scanning radio frequencies for GNSS satellite signals. Upon receiving a radio signal from a GNSS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

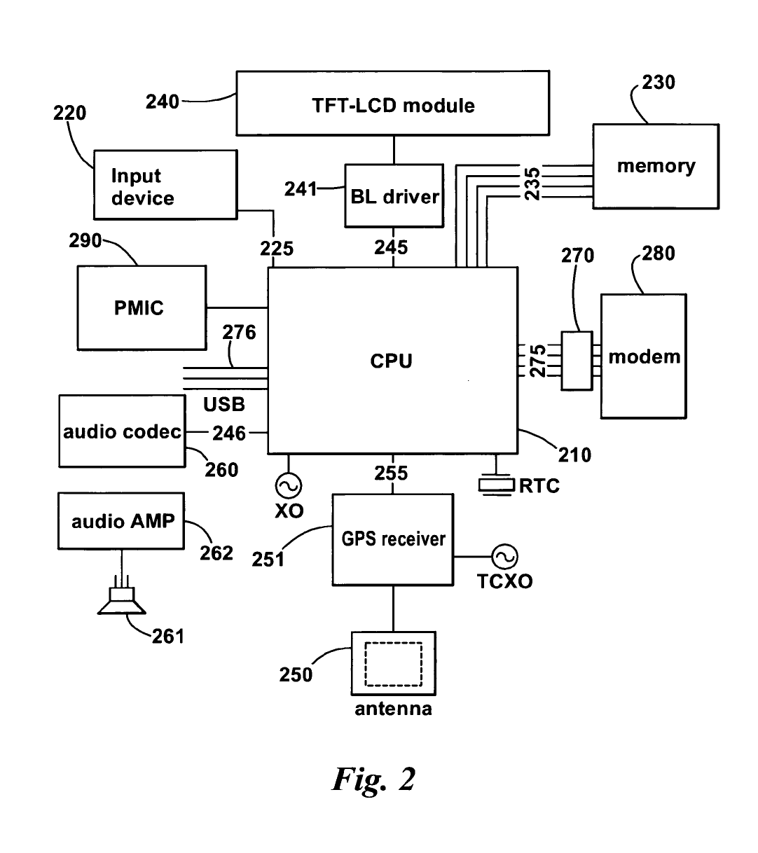

FIG. 2 is an illustrative representation of electronic components of a navigation device 200 according to a preferred embodiment of the present invention, in block component format. It should be noted that the block diagram of the navigation device 200 is not inclusive of all components of the navigation device, but is only representative of many example components.

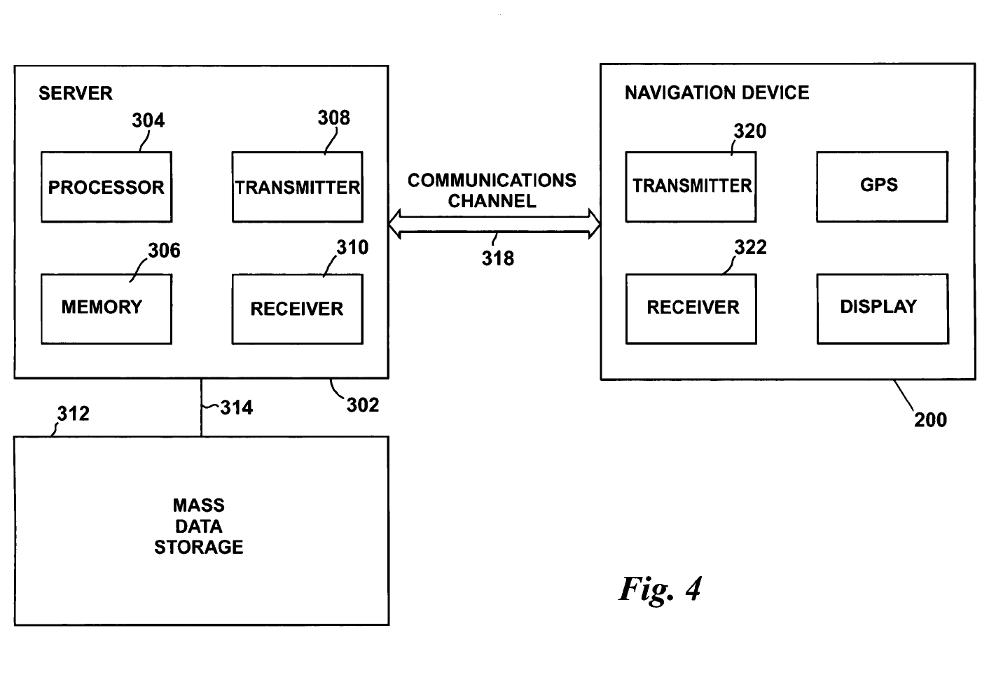

The electronic components of the navigation device 200 are located within a housing, such as that shown in FIGS. 4A and 4B. The navigation device includes a processing device 210 connected to an input device 220 and an output device in the form of a display screen, in this embodiment an LCD 240, comprising a backlight driver 241 connected with the processing device 210. The input device 220 can include a keyboard device, voice input device, touch panel and/or any other known input device utilised to input information; and the display screen 240 can include any type of display screen such as an LCD display, for example. In this arrangement the input device 220 and display screen 240 are integrated into an integrated input and display device, including a touchpad or touch screen input so that a user need only touch a portion of the display screen 240 to select one of a plurality of display choices or to activate one of a plurality of virtual buttons.

The navigation device may include a further output device 260 to 262, for example a loudspeaker 261, an audio amplifier 262 and audio codec 260. The audio device 260 to 262 can produce audio commands for directing the user in accordance with a determined navigable route.

In the navigation device 200, processing device 210 is operatively connected to and set to receive input information from input device 220 via a connection 225, and operatively connected to at least one of display screen 240 and output device 260, via output connections 245 and 246, to output information thereto. Further, the processing device 210 is operably coupled to a memory resource 230 via connection 235. The memory resource 230 comprises, for example, a volatile memory, such as a Random Access Memory (RAM) and a non-volatile memory, for example a digital memory, such as a flash memory. The memory resource 230 has stored therein map data describing navigable paths of a region. The map data includes information on the location of traffic control signals, such as traffic lights, and the any regular switching cycle(s) carried out by those traffic control signals.

The navigation device 200 further comprises a connection 270 for detachably connecting to a cellular modem 280, such as a mobile telephone, for receiving broadcast signals, such as BCCH, from base stations of cellular networks. The connection 270 may be used to establish a data connection between the navigation device 200 and the Internet or any other network for example, and/or to establish a connection to a server via the

Internet or some other network for example. In another embodiment, device 280 may be a portable television receiver or a radio receiver that can receive TMS/RDS information.

FIG. 2 further illustrates an operative connection between the processing device 210 and a positioning device for determining a position of the navigation device, in the embodiment a GNSS antenna 250 and receiver 251 via connection 255. The antenna may be a GNSS patch antenna or helical antenna for example.

Further, it will be understood by one of ordinary skill in the art that the electronic components shown in FIG. 2 are powered by power source 290, in this case a power management integrated circuit 290, in a conventional manner.

A wired connection 276, in this embodiment a USB connection, is also provided for connecting the processing device 210 to a computer or the like. Such a connection can be used for software/firmware updates and/or map updates.

As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

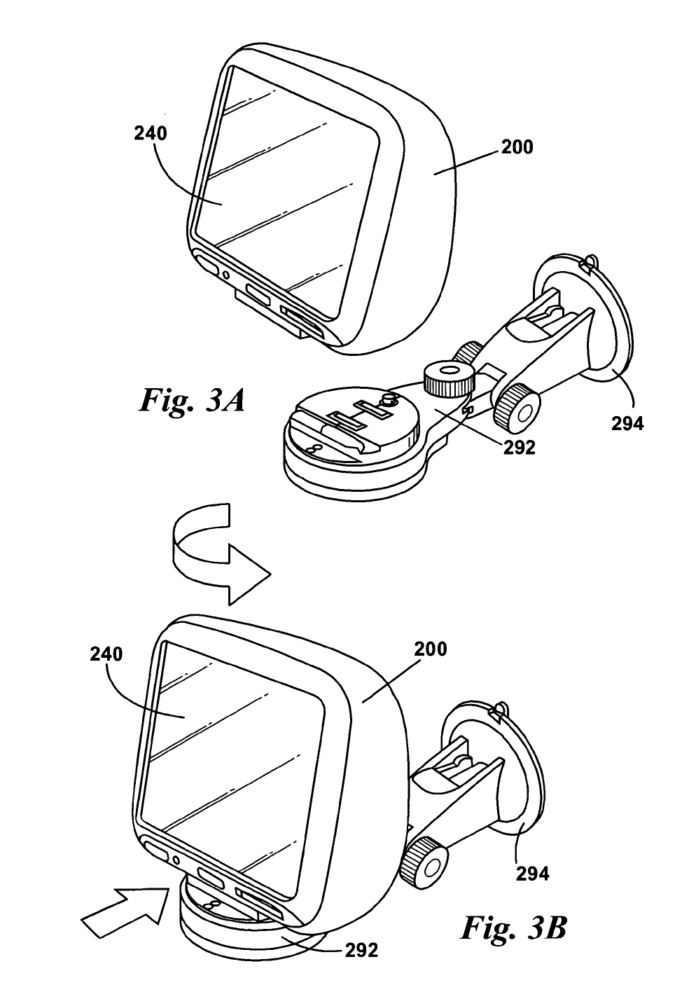

In addition, the portable or handheld navigation device 200 of FIG. 2 can be connected or “docked” in a known manner to a vehicle such as a bicycle, a motorbike, a car or a boat for example by using the mounting device 292/294 shown in FIGS. 3a and 3b. Such a navigation device 200 is then removable from the docked location for portable or handheld navigation use.

It will be understood that in a different embodiment the cellular modem 280 is integral with the navigation device. The mobile phone technology within the navigation device 200 can include internal components as specified above, and/or can include an insertable card (e.g. Subscriber Identity Module or SIM card), complete with necessary mobile phone technology and/or an antenna for example. It will be understood, however, that a SIM card may not be necessary as the invention does not require the subscription to a cellular network.

Referring now to FIG. 4, the navigation device 200 may establish a “mobile” or telecommunications network connection with a server 302 via the cellular modem 280 establishing a digital connection (such as a digital connection via known Bluetooth technology for example). Thereafter, through its network service provider, the cellular device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using the Internet (such as the World Wide Web) for example, can be done in a known manner. This can include use of TCP/IP layered protocol for example. The mobile device can utilize any number of communication standards such as DVB-H, DVB-T, CDMA, GSM, Wi-Max, TMC/RDS, etc.

As such, an Internet connection may be utilised which is achieved via data connection, via a mobile phone or mobile phone technology within the navigation device 200 for example. For this connection, an Internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the Internet).

The navigation device 200 can further complete a data connection with the mobile device, and eventually with the Internet and server 302, via existing Bluetooth technology for example, in a known manner, wherein the data protocol can utilize any number of standards, such as the GSRM, the Data Protocol Standard for the GSM standard, for example.

For GRPS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 4 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processing device 304 operatively connected to a memory 306 and further operatively connected, via a wired or wireless connection 314, to a mass data storage device 312. The processing device 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processing device, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processing device 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processing device 304 in the server 302 may be used to handle the bulk of the processing needs; however, processing device 210 of navigation device 200 can also handle much processing and calculation, oftentimes independent of a connection to a server 302.

FIGS. 3A and 3B are perspective views of a navigation device 200. As shown in FIG. 3A, the navigation device 200 may be a unit that includes an integrated input and display device 290 (a touch panel screen for example) and the other components of FIGS. 2 and 4 (including but not limited to internal GPS receiver 250, processing device 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 3B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 3B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

When this user switches on their PND, the device acquires a GNSS fix and calculates (in a known manner) the current location of the PND. Using this current location the PND can determine a navigable route in accordance with conventional algorithms and provide directions to a user.

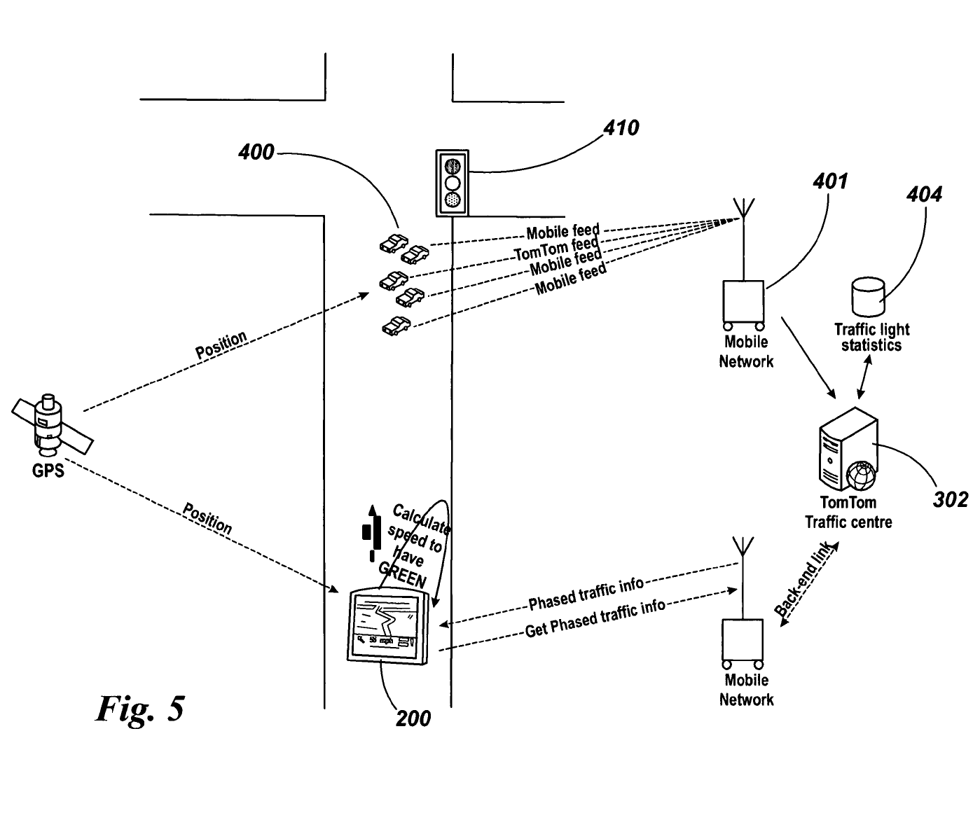

Now referring to FIG. 5, as the user of the navigation device 200 travels the route, the navigation device 200 receives information from server 302 on the status of traffic control signals 410. The information may be limited to traffic control signals 410 within a particular distance from the current position of the navigation device 200 or to those traffic control signals 410 along the route that has been predetermined by the navigation device 200. In order for the server 302 to select the required information, the navigation device may send to the server 302 regular updates on its position and/or the predetermined route. The information on the status of the traffic control signals may be pushed to the navigation device 200 at regular intervals or sent to the navigation device 200 in response to a request from the navigation device 200.

The processor 210 of the navigation device 200 utilizes the location information obtained from the GNSS receiver, the information on the status of the traffic control signals 410 and information on the regular cycles carried out by the traffic control signals 410 stored in memory 230 to determine a speed to travel to arrive at a traffic control signals 410 on the route when the traffic control signals have a condition giving the driver the right of way. For example, when the traffic control signal is a traffic light 410, a speed to travel such that the driver arrives at the traffic light 410 when the traffic light 410 displays a green light to the driver.

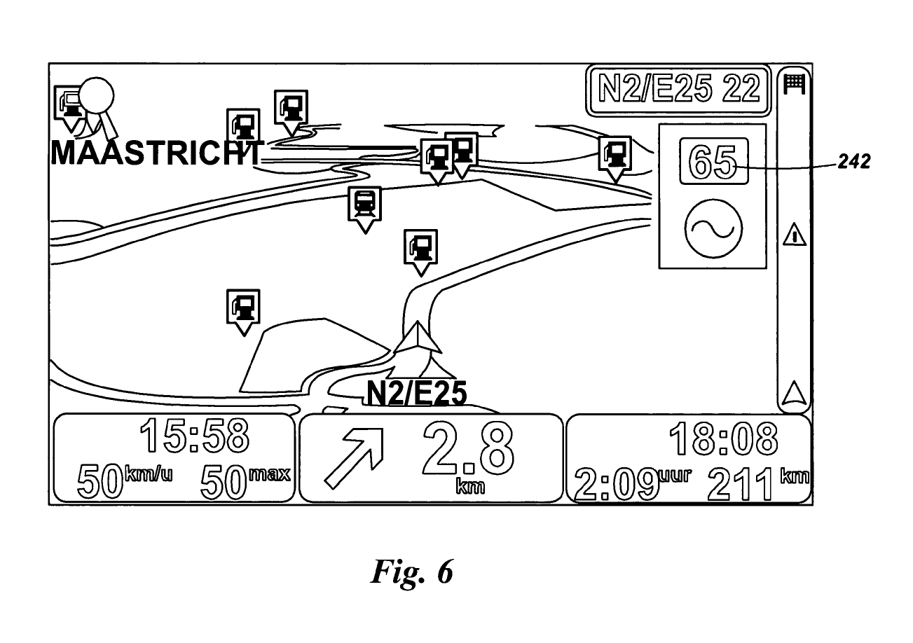

The processor 210 then causes the audio and/or visual outputs of the navigation device to output an instruction to indicate the determined speed to travel. In this embodiment, the instruction is output as an image on display 240 as shown in FIG. 6. As is conventional, the display 240 displays a map of the local area together with other useful information such as the location of petrol stations, time and current speed. However, in addition to these conventional elements, the display includes an indicium 242 indicating the speed to travel to arrive at the next and optionally one or more forthcoming or upcoming traffic control signal, further optionally within a predetermined threshold distance of the current position, at a time when the driver will have right of way. In this example, the indicium shows 65 Km/h.

In an alternative embodiment, the processor 210 may determine a range of speeds which the driver can travel to arrive at the traffic control signal at an appropriate time. The processor 210 may cause the speaker 261 to output a signal if the speed of the navigation device 200 falls outside of that range.

When calculating the speed to travel, the processor may take into account a speed of traffic along navigable paths of the route, and may also determine that, for that route, the next and one or more subsequent sets of traffic signals might be passed without halting if a particular speed of travel is observed substantially immediately and subsequently through the next, and one or more subsequent junctions at which such traffic signals are present. Of course, the processor may only determine the optimum, desired or suitable speed of travel which would ensure, or at least make improve the likelihood, that the next appearing traffic signal may be passed without halting as a result of that signal changing so as to arrest traffic.

In this embodiment, the processor 210 may use the speed profiles along the navigable paths stored in the memory 230 to determine a maximum speed along navigable paths of a route at a relevant time (which may be different from the speed limit) and the determined speed to travel must be below this maximum speed. For example, the speed limit on a road may be 80 km/h but the processor may determine that at 9 am, on average, vehicles travel along that road at a speed of 65 km/h. Therefore, the processor sets a limit on the speed that the vehicle can travel to be 65 km/h not the 80 km/h speed limit. In this way, there is a reduced chance that the driver is instructed to obtain a speed that is unachievable for the current road conditions.

The speed profiles may also be supplemented (or even replaced with) with “real-time” information obtained from other vehicles 400 ahead on the road. Such a scenario is indicated in FIG. 5. In this example, navigation devices or other portable processing devices that can determine current location, such mobile telephones, in other vehicles 400 communicate their position and/or speed to server 302, possibly via a mobile network 401. The server 302 processes this information to determine an average speed on the navigable paths. These average speeds are then communicated to the navigation device 200.

The server 302 may also estimate a condition of a traffic control signal from the speeds and/or positions of the vehicles 400. For example, if the vehicles 400 are stopped by the traffic control signal 410 or are slowing down as they approach the traffic control signal 410, the server 302 may determine that the traffic control signal, in this case a traffic light 410 is red. However, if traffic is free flowing passed the traffic light then the server 302 may determine that the traffic light is green. Such a scheme may be particularly useful when other sources of the traffic control signal status are unavailable.

The server 302 may also receive information from third part sources 404 on the status of the traffic control signals.

The statuses of the traffic control signals determined by the server 302 are sent to the navigation device 200, as described above.

The navigation device may be also able to operate in a “free-driving” mode wherein a predetermined route has not been calculated.

In an alternative embodiment, the processor 210 of the navigation device does not calculate the speed to travel but these calculations are carried out by the server 302, the server 302 sending the determined speeds to the navigation device 200. In such an embodiment, the navigation device 200 communicates its position, and optionally a predetermined route, to the server 302 and the server 302 calculates a speed to travel such that the navigation device arrives at the next traffic control signal when the traffic control signal indicates that the vehicle has right of way.

It will be understood that modifications and alterations can be made to the above described embodiment without departing from the scope of the invention as defined by the claims.

For example, if a specified time of travel is provided when the user will travel a route, the processor 210 of the navigation device 200 or the server 302 may determine a speed to travel along the route before the user commences travelling the route. Adjustments to these speeds of travel may be made as the user travels the route. In this way, a prediction can be made of the time it will take to travel a route taking into account the speeds that need to be travelled to arrive at traffic control signals at an appropriate time.

1. A portable processing device comprising means for receiving positioning data indicative of a position of the processing device, an output device, a processor and memory having stored thereon map data, wherein the processor is arranged to determine a position on the map data based on the positioning data, determine a speed to travel to arrive at a traffic control signal, which switches between two or more conditions to indicate a right of way, when the traffic control signal has a particular condition and cause the output device to output at least one of an audio and visual instruction to indicate the determined speed to travel.

2. The portable processing device according to claim 1, wherein the traffic control signal is a traffic light and the particular condition is a green light.

3. The portable processing device according to claim 2, wherein the processor is arranged to identify from the map data whether there is a traffic control signal on a route, determine a condition of the traffic control signal at a specified time and determine a speed to travel to arrive at a traffic control signal when the traffic control signal has the particular condition.

4. The portable processing device according claim 3, further comprising a data connection link for receiving traffic information on the condition of traffic control signals, the processor arranged to use the received traffic information to determine a current condition of an identified traffic control signal and from the current condition the speed to travel to arrive at a traffic control signal when the traffic control signal has the particular condition.

5. The portable processing device according to claim 3, wherein the processor is arranged to take into account a speed of traffic along navigable paths of the route when determining the speed to travel to arrive at a traffic control signal when the traffic control signal has the particular condition.

6. The portable processing device according to claim 3, wherein the memory has stored therein data on switching cycles of traffic control signals and the processor is arranged to use the data on the switching cycles to determine the speed to travel.

7. The portable processing device according to claim 3, wherein the processor is arranged to use traffic information received by the portable processing device to determine the condition of traffic control signals.

8. The portable processing device according to claim 1, comprising a wireless receiver for communicating with transmitters that communicate the speed to travel.

9. The portable processing device according to claim 1, wherein the route is a route determined from a destination identified by the user.

10. The portable processing device according to claim 1, wherein the route is a predicted route determined from an extrapolation of a current direction of travel.

11. A server comprising a processor, a data link for communicating with portable processing devices and a data link for receiving information indicative of the condition of traffic control signals, the processor arranged to process the information to determine the condition of the traffic control signals and communicate the condition of the traffic control signals to at least one of a remote processing device and one or more of the portable processing devices.

12. A server comprising memory having stored thereon map data and data concerning the cyclic condition of traffic control signals, which switch between two or more conditions to indicate a right of way, a processor and a data link for communicating with portable processing devices, the processor arranged to, in response to receiving a position fix from a portable processing device, determine a speed to travel to arrive at at least one of the traffic control signals along the route when the at least one traffic control signal has a particular condition and communicate the speed to travel to the portable processing device.

13. (canceled)

14. A method of providing driving suggestions comprising:
determining a position on map data based on an output from a positioning device,
identifying a traffic control signal, which switches between two or more conditions to indicate a right of way, on a route,
determining a speed to travel to arrive at the traffic control signal when the traffic control signal has a particular condition, and
causing at least one of an audio and visual output of an instruction to a user of a vehicle indicating the determined speed to travel.

15. A non-transitory data carrier having instructions stored thereon, which, when executed by a processor, causes the processor to carry out the steps described in claim 1.
